(19) United States
(12) Patent Application Publication
(10) Pub. No.: US 2017/0305096 A1
(43) Pub. Date: Oct. 26, 2017

(54) METHODS AND MACHINES FOR PRODUCING TUBES BY WINDING STRIP MATERIAL AROUND A FORMING MANDREL

(71) Applicant: UNIVERSAL TISSUE TECHNOLOGY S.R.L., Lucca (IT)

(72) Inventors: Daniele Dettori, Capannori (IT); Giovanni Bertoli Barsotti, Viareggio (IT); Gionata Pardini, Viareggio (IT)

(21) Appl. No.: 15/508,030

(22) PCT Filed: Jul. 28, 2015
(86) PCT No.: PCT/EP2015/067249

§ 371 Date: Mar. 1, 2017

(30) Foreign Application Priority Data
Sep. 2, 2014 (IT) BO2014A000476

(51) Int. Cl. B31C 3/00; B26D 5/08; B26D 3/16; B31C 11/00; B26D 1/60

(52) U.S. Cl. CPC B31C 3/00; B31C 11/00; B26D 1/60; B26D 3/16; B26D 5/086

(57) ABSTRACT

A machine is shown having a winding unit (3) and a cutting unit (7) to cut a tube (T) being formed around a mandrel (5). The cutting unit (7) has a rotating cutting blade (9) provided with motion along a circular trajectory, defined by means of a system of cross guides and a fastening to a center of a circular trajectory. The position of the center (33B) of the circular trajectory of the rotating cutting blade (9) is changed according to the direction of movement of the blade with respect to the mandrel, so that the rotating cutting blade (9) cuts the tube (T) during a forward movement and is released form the tube during a backward movement. Methods for production of tubes by means of helical winding of one or more strips of web material around a mandrel are shown as well.

### BACKGROUND OF THE INVENTION

The invention relates to machines for the production of tubes by means of helical winding of one or more strips of web material around a mandrel and methods for production of such tubes. More particularly, even if not exclusively, the invention relates to the production of tubes made of cardboard or similar material, for winding rolls of cellulose material, such as tissue paper or the like, or other continuous web material.

In the field of manufacturing rolls of wound web material, such as plastic film, metallized sheets, paper, tissue paper for producing toilet paper, kitchen towels etc., tubular winding cores are often used. These tubular winding cores are formed by helically winding one or more strips of web material, typically cardboard. For the production of these tubular cores machines are used, which continuously produce a tube by helically winding one or more strips around a mandrel, the tube being cut, while being formed around the mandrel, into sections, each of which forms a tubular winding core of a roll, by means of a winding or rewinding machine.

U.S. Pat. No. 5,873,806 discloses a machine of this type for the production of cardboard tubes. To form the tube around the mandrel in continuous fashion, the machine comprises a winding unit, which helically winds one or more strips of web material around the mandrel. The winding unit can comprise, for example, a motorized belt, forming a turn around the mandrel, so as to drive one or more strips of web material, previously glued on at least one face, to be wound around the mandrel. Downstream of the winding unit, along the extension of the mandrel, a cutting unit is provided comprising at least one rotating cutting blade to cut the tube, being formed continuously around the mandrel, into single sections. The cutting unit is configured so that the blade follows the forward movement of the tube along the mandrel during the cutting phase: it substantially moves at the same linear speed as the tube being formed, and moves away from it between one cut and the following one. To control these movements of the rotating cutting blade in the tube manufacturing machines, different systems have been developed, that are more or less complex and difficult to be managed.

The cutting phase, done in the core-winders for producing the tubular cores for winding web material, for example paper and the like, is particularly significant in terms of quality of the tubular core and, thus, in terms of winding efficiency for the web material to form rolls. The cut shall be precise, the initial and end points of the cut shall be correct and overlapped, and the rotating blade shall enter the material thickness in a gradual and constant way. The cut shall also be as orthogonal as possible to the axis of the tube, and the speed of the disc-shaped blade shall be adjustable, to achieve high quality. Moreover, the cutting unit shall be simple from a constructive point of view; it shall be reliable, easy and economical to be maintained, and shall require limited and easy adjustments.

A need therefore exists for a tube producing machine by means of winding around a mandrel, with a system for cutting the tube into single sections or tubular cores that is easy and reliable.

### SUMMARY OF THE INVENTION

According to an aspect, a machine is provided for the production of tubes, comprising: a mandrel, around which a tube is formed by winding at least one strip of web material, the mandrel having a longitudinal axis; a winding unit to wind said at least one strip of web material around the mandrel; a cutting unit comprising at least one rotating cutting blade provided with reciprocating motion to cyclically cut the tube being formed around the mandrel. The rotating cutting blade is constrained to move with reciprocating motion along a circular trajectory. The center of the circular trajectory is controlled to be cyclically moved:
into a position closer to the mandrel longitudinal axis during a forward stroke of the rotating cutting blade in the same direction as the feed direction of the tube being formed, where the rotating cutting blade cuts the tube;
and into a farther position from the mandrel longitudinal axis during a back stroke of the rotating cutting blade in a direction opposite to the feed direction of the tube being formed.

The rotating cutting blade can be arranged with its own axis of rotation substantially parallel to the longitudinal axis of the mandrel, and can be provided with a toothed cutting edge.

According to a further aspect, a machine is provided for the production of tubes, comprising: a mandrel, around which a tube is formed by winding at least one strip of web material, the mandrel having a longitudinal axis; a winding unit to wind said at least one strip of web material around the mandrel; a cutting unit comprising at least one rotating cutting blade mounted on a carriage provided with reciprocating motion in a direction substantially parallel to the mandrel longitudinal axis. The rotating cutting blade is mounted on a slide carried by the carriage and moving with respect to said carriage in a direction substantially transverse to the mandrel longitudinal axis. The slide is connected to a control actuator causing a controlled movement of the slide to move the slide towards and away from the mandrel, so as to put the rotating cutting blade in an active cutting position, during a forward stroke in the same direction as the feed direction of the tube being formed, and in an inactive position, during a back stroke.

For example, the slide can be fixed to the actuator by means of a connecting rod articulated at an end to the slide and, at the opposite end, to the actuator. In this way, thanks to the arrangement of carriage and slide, this latter moves along a circular trajectory, due to the effect of the combined motion of the slide on a crosswise guides system. The center of the circular trajectory is defined by the hinge axis, or axis of articulation, between connecting rod and actuator. The actuator, moving the articulation point between actuator and connecting rod, changes the position of the circular trajectory of the slide, so that the rotating cutting blade is in cutting position and in idle position, according to the direction of motion along the circular trajectory.

In other embodiments, the actuator can give the axis of articulation between connecting rod and actuator a movement coordinated and synchronized with the translation movement of the slide with respect to the carriage and that of the carriage with respect to the mandrel. This additional controlled movement of the articulation axis can change the shape of the trajectory of the slide and, therefore, of the rotating cutting blade.

According to a further aspect, the invention relates to a method for forming tubular cores from a continuous tube, comprising the following steps:
forming a tube around a mandrel in continuous fashion, said tube moving forward along the mandrel;
arranging a cutting unit along the mandrel, comprising a rotating cutting blade;
moving the rotating cutting blade along a circular trajectory cyclically performing: a forward stroke, during which the rotating cutting blade interacts with the tube being formed around the mandrel, moving forward in the same direction thereof to cut the mandrel; and a back stroke, during which the rotating cutting blade does not interact with the tube being formed.

The center of the circular trajectory is arranged closer to the mandrel during the forward stroke and farther from the mandrel during the back stroke.

### BRIEF DESCRIPTION OF THE DRAWINGS

The invention will be better understood by following the description below set forth with reference to the attached drawing, wherein he same numbers in the figures indicate identical or equivalent parts. More in particular, in the drawing:

FIG. 1 is an axonometric view of a machine for the production of tubes by means of winding around a mandrel;

FIG. 1A is a diagram of the winding system;

FIG. 2 is an axonometric view of the cutting unit in one embodiment;

FIG. 3 is an axonometric view of the cutting unit from a different angle;

FIG. 4 is a plan view of the cutting unit according to line IV-IV of FIG. 2; and

FIG. 5 shows a side view according to line V-V of FIG. 4.

### DETAILED DESCRIPTION OF EMBODIMENTS

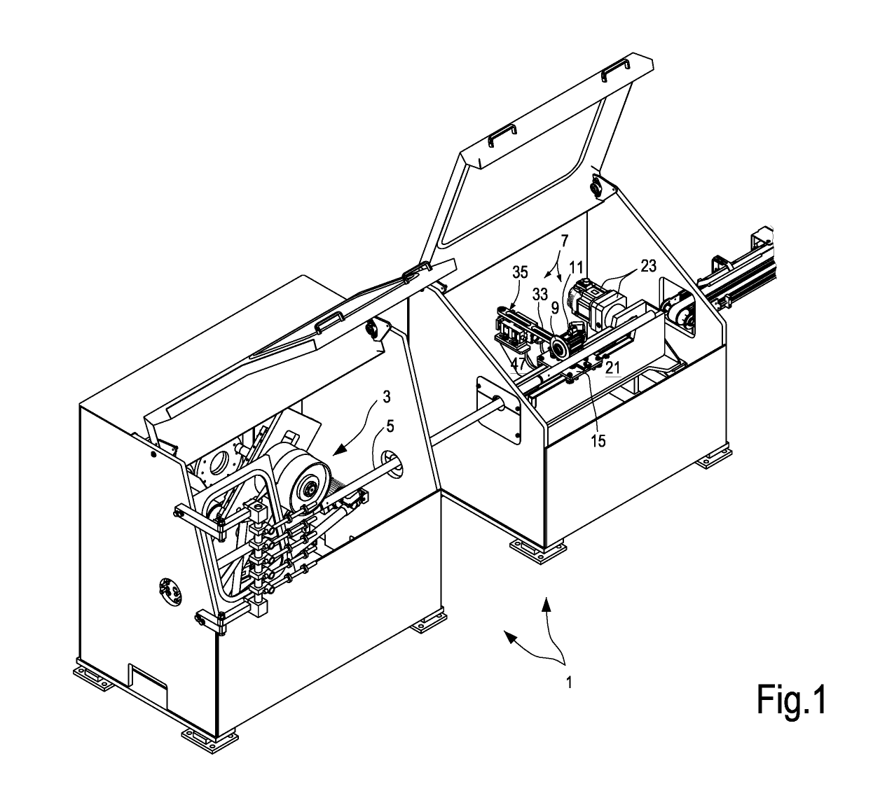

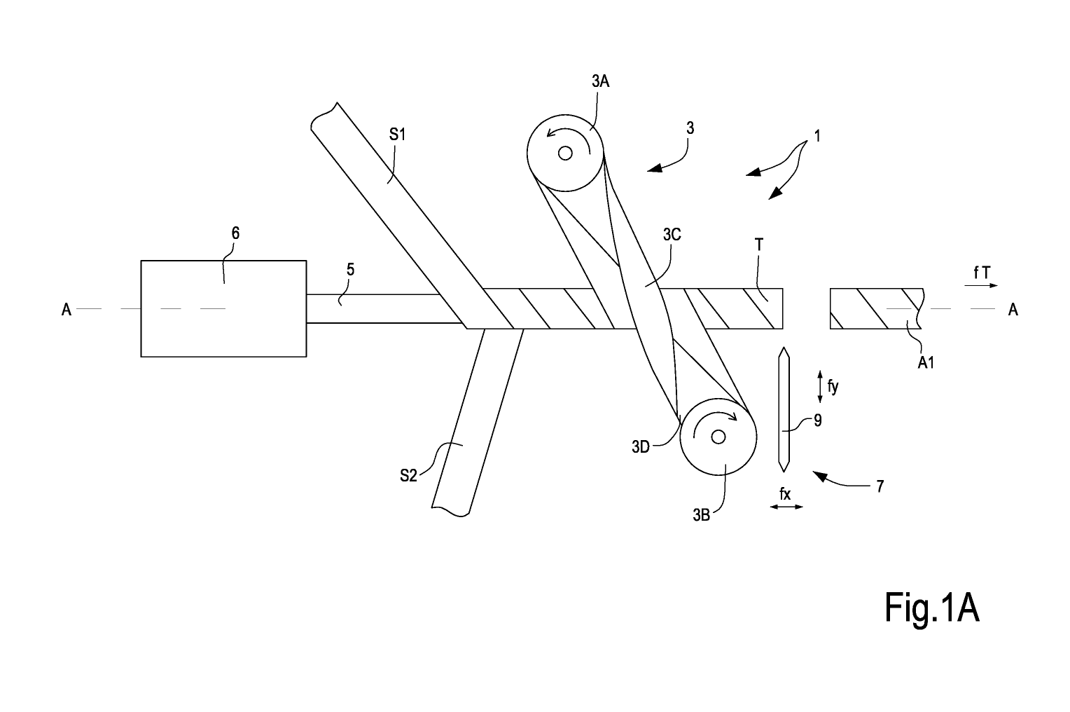

FIG. 1 shows an axonometric view of a machine for the production of a tube of web material wound around a mandrel. The machine is indicated as a whole with number 1; it is provided with a cutting unit to divide the tube into single sections or tubular cores, destined for example for winding a web material, like tissue paper or the like.

The general structure and the operation of the machine for the production of tubes are known per se and will not be described in greater detail. Moreover, the structure of the machine can be different than that schematically indicated in FIG. 1 and briefly described below. Essentially, what is important for the invention is that the machine has a mandrel, around which a tube is continuously formed in a known manner, by helically winding one or more strips of web material that can be supplied to the machine 1 continuously.

The machine 1 comprises a winding unit 3 that helically winds one or more strips of web material around a mandrel 5, the strips being supplied continuously, suitably inclined with respect to the mandrel 5. The turns formed by the helically wound strip or strips of web material partially overlap, forming the continuous tubular article moving along the mandrel 5. In other embodiments, different systems can be used for winding the strips, for instance winding them not helically but parallel to the axis of the mandrel 5.

Downstream of the winding unit 3 a cutting unit is arranged, indicated as a whole with number 7; the function of this unit is to subdivide the tube, which is continuously formed around the mandrel 5, into single sections.

The operation of the machine 1 for the production of tubes is known per se; it is schematically shown in FIG. 1A and briefly described below. In the diagram of FIG. 1A, two strips S1 and S2 of web material are supplied to the machine 1; one of these strips can be previously provided with glue on a face thereof. The strips S1 and S2 are supplied to the mandrel 5 and are helically wound around it. To this end, the mandrel can be motorized, fixed, or even mounted idle onto a stationary structure 6. The movement of the strips S1 and S2 around the mandrel 5 is provided by means of the winding unit 3 that, in the diagram of FIG. 1A, comprises two pulleys 3A, 3B around which a formation belt 3C is driven. At least one of the pulleys 3A, 3B is motorized. In some embodiments, both the pulleys can be motorized. The belt 3C forms a turn 3D around the mandrel 5. The strips S1 and S2 pass between the mandrel 5 and the inner surface of the belt 3C, in correspondence of the turn 3D wound around the mandrel 5. The friction between the strips S1, S2 and the surface of the belt 3C causes the continuous supply of the strips S1, S2 being wound.

In other embodiments, it is possible to supply the winding unit 3 with only one strip of web material, whose helical turns partially overlap each other to form a continuous tube.

The cutting unit 7 comprises a rotating cutting blade 9, which is provided with a forward and backward movement according to fy so as to move towards and away from a longitudinal axis A-A of the mandrel 5. The rotating cutting blade 9 is also provided with a movement according to the arrow fx, substantially parallel to the longitudinal axis A-A of the mandrel 5. The rotation axis of the rotating cutting blade is directed so as to be substantially parallel to the longitudinal axis A-A of the mandrel 5.

Essentially, to divide the tube T, being formed around the mandrel 5 in continuous fashion by winding the strips S1, S2, into single tubular cores A1, the cutting blade 9 periodically moves towards the mandrel 5 with a transverse movement fy, until engaging the tube T, and moves according to fx parallel to the axis A-A, thus following the forward movement of the tube T, at a speed equal to the longitudinal feeding speed of the tube T along the mandrel 5. While being formed, the tube T rotates around the longitudinal axis A-A of the mandrel 5. The blade 9 causes therefore a cut along the whole circumference extension of the tube T. The rotating cutting blade 9 remains engaged in the tube T for a time enough for the same tube to make at least a complete turn around the longitudinal axis A-A, after which the tube is completely cut by the rotating cutting blade 9. Once the cut has been made, the rotating cutting blade 9 can move backwards according to fy, moving away from the longitudinal axis A-A of the mandrel 5. Once released from the tube T, the rotating cutting blade 9 can move backwards according to fx, with a movement opposite to the feeding direction fT of the tube along the mandrel 5, achieving again a position, wherefrom it starts a subsequent cutting cycle.

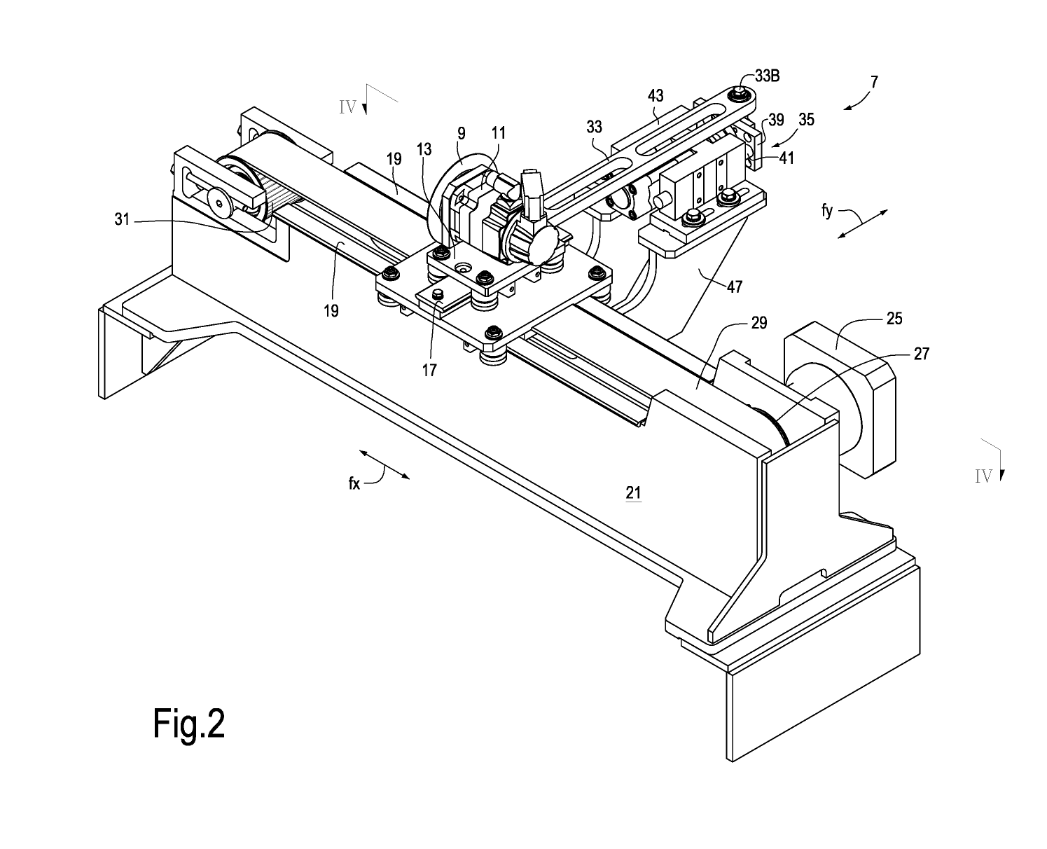

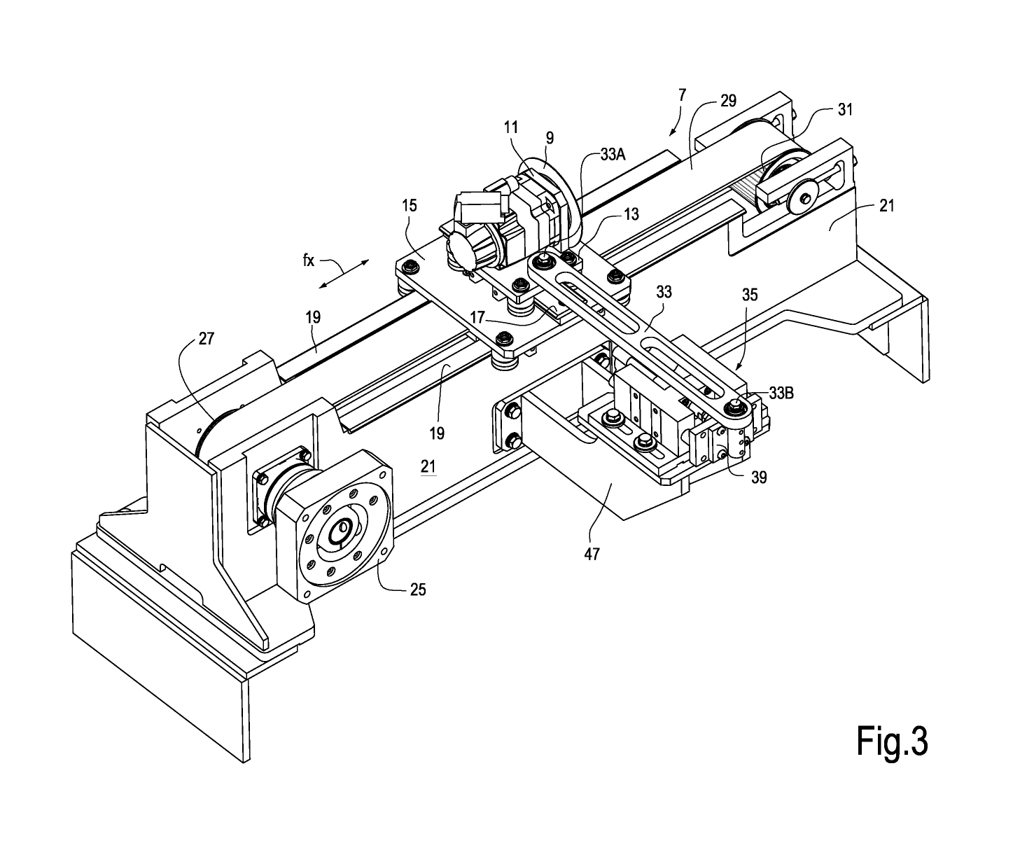

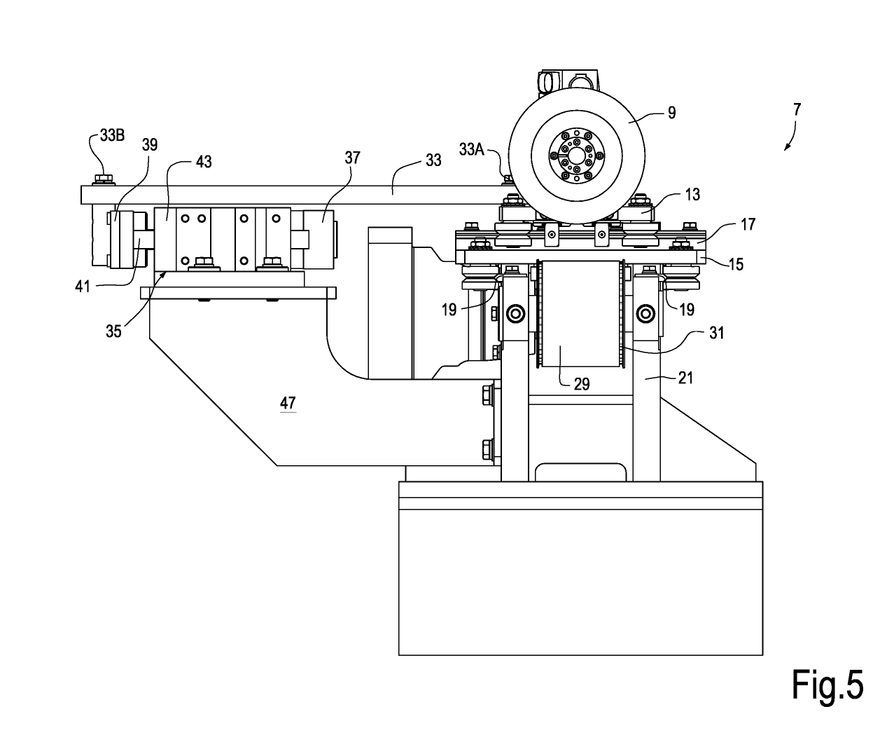

The cutting unit 7 comprises an innovative structure to control the movement of the rotating cutting blade 9. The structure of the cutting unit 7 is detailed below with specific reference to FIGS. 2-5 showing the cutting unit 7 separately from the other components of the machine 1.

In some embodiments, the rotating cutting blade 9 is a disc-shaped toothed blade. Thanks to the teeth, the rotating cutting blade 9 can cut the tube T by chip removal without the need of exerting a particularly high pressure onto the tube.

In advantageous embodiments, the rotating cutting blade 9 is motorized. To this end, a suitable actuator is provided. For example, in some embodiments, an electric motor 11 can be provided. The electric motor 11 is preferably a brushless motor. In other embodiments, a rotary pneumatic or hydraulic actuator, or the like, can be provided. Advantageously, the rotating cutting blade 9 can be directly keyed on the actuator shaft; when an electric motor is provided, the blade is directly keyed onto the shaft of the motor. In this way, the number of transmission members is reduced, and the cutting unit is thus simpler, more economical and reliable.

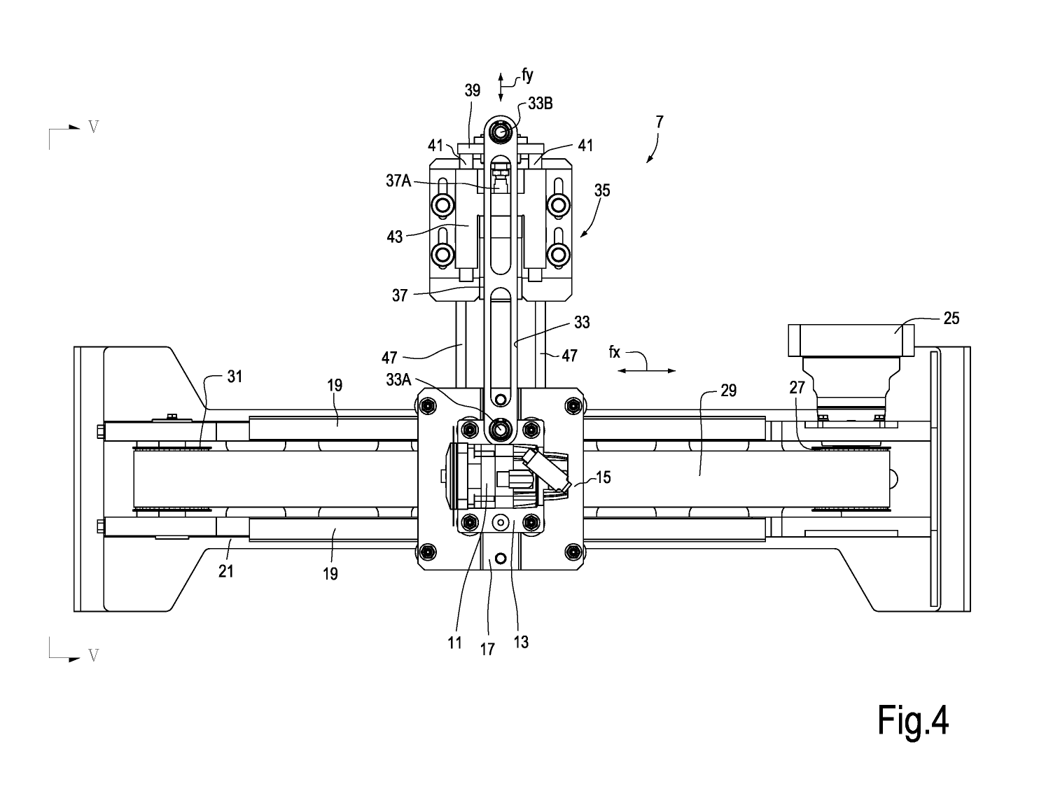

In some embodiments the rotating cutting blade 9 and the motor 11 are installed onto a slide 13, provided with a double movement according to the double arrow fx and according to the double arrow fy (see in particular FIG. 4), in a direction that is substantially parallel and substantially orthogonal, respectively, to the longitudinal axis A-A of the mandrel 5 around which the strip(s) S1, S2 of web material are wound and the tube T is formed.

In some embodiments, the slide 13 is mounted onto a carriage 15. The slide 13 can move according to the direction fy with respect to the carriage 15. The carriage can move according to fx.

In some embodiments, the carriage 15 may be provided with a guide 17, with which the slide 13 slidingly engages. The guide 17 extends according to a direction substantially orthogonal to the longitudinal axis A-A of the mandrel 5.

The carriage 15 can be guided, in the movement according to fx, along a guide substantially parallel to the longitudinal axis A-A of the mandrel 5. The guide can be comprised of two tracks 19 mounted on a support 21, integral with the fixed structure of the machine 1.

The movement of the carriage 15 according to the double arrow fx can be imparted by means of an electric motor 23, illustrated only in FIG. 1 and omitted in FIGS. 2-5.

Number 25 indicates the mounting flange of the motor 23. The motor 23 can drive a first motorized pulley 27 into rotation. The pulley 27 is preferably a toothed pulley, around which a toothed belt 29 can be driven. The use of a toothed belt 29 is particularly useful to have a punctual control of the movement of the carriage 15, as it will be clear from the description below. In other embodiments, a chain or a different continuous flexible member can be used instead of the toothed belt 29.

The belt 29 can be driven around a second pulley 31, idly mounted on the support 21. The belt 29 forms a flexible actuating member, fastened to the carriage 15. More in particular, the carriage 15 can be fixed to the upper branch of the belt 29. The motor 23 gives the belt 29, and thus the carriage 15, a reciprocating motion according to the double arrow fx. The motor 23 can be an electronically controlled electric motor, for example a brushless motor.

The use of a belt driven around toothed pulleys allows having a transmission system that is very simple, economical, light and easy to be maintained.

However, other systems for the reciprocating motion of the carriage 15 can be used, suitable to transform the rotary motion of the motor into rectilinear motion. For instance, pinion-rack systems, or rod-crank mechanisms can be used.

In advantageous embodiments, the slide 13 moves according to the double arrow fy by means of a mechanism comprising a connecting rod 33 hinged at 33A to the slide 13 and at 33B to a control actuator, indicated as a whole with number 35.

The control actuator 35 can comprise a linear actuator, for instance a cylinder-piston actuator 37, of the hydraulic or pneumatic type. In other embodiments, not shown, the control actuator 35 can be an electric jack, a linear motor or an equivalent actuator.

Number 37A indicates the rod of the piston of the cylinder-piston actuator 37. The rod 37A can be fastened to a plate 39 guided by means of a guiding arrangement, comprising for instance bars 41 sliding in fixed guides 43. In this way, a movement of the cylinder-piston actuator 37 causes a movement of the plate 39 according to the double arrow fy. The articulation 33B of the connecting rod 33 can be in correspondence of the plate 39. In this way, the movement of the plate 39 according to fy, controlled by means of the cylinder-piston actuator 37, causes a movement of the articulation 33B of the connecting rod 33 in the same direction fy.

In some embodiments, the control actuator 35 can be supported by means of brackets 47 integral with the support 21 carrying the guiding tracks 19 for the carriage 15, as well as the motorization of the belt 29 described above.

The linear movement of the cylinder-piston actuator 37 according to fy causes a corresponding movement in the same direction of the hinge 33A, joining the connecting rod 33 to the slide 13. Therefore, the cylinder-piston actuator 37 can move the slide 13 according to the double arrow fy.

As shown in particular in FIG. 1, the carriage 15 with the slide 13, the rotating cutting blade 9 and the motor 11 are arranged at a side with respect to the mandrel 5. During the movement, caused by the motor 23 by means of the belt 21, the slide 13 follows a circular trajectory, whose center is in correspondence of the articulation 33B that is held in fixed position. The rotating cutting blade 9, and its cutting edge, follows the same trajectory as the slide 13. The position of this trajectory can be changed by means of the cylinder-piston actuator 37, whose movement displaces the fulcrum or hinge 33B.

Therefore, the cutting unit 7 operates as described below. During the forward stroke of the carriage 15 according to the arrow fT in the feed direction of the tube T being formed, the position of the fulcrum, or hinge 33B is such that the circular trajectory followed by the cutting edge of the rotating cutting blade 9 intersects the tube T being formed around the mandrel 5. In the illustrated example, during this phase the piston of the cylinder-piston actuator 37 is retracted.

During the stroke of the carriage 15 in the opposite direction, the position of the hinge 33B is farther away from the axis of the mandrel 5, due to the effect of the translation of the hinge 33B caused by the stroke of the cylinder-piston actuator, whose piston (in the illustrated example) is extracted.

Therefore, the cylinder-piston actuator 37, or other suitable actuator (preferably a linear actuator) allows modifying the position of the trajectory of the rotating cutting blade 9, from a position where it interacts with the tube T (forward stroke of the carriage 15, arrow fT) to a position where it does not interact with the tube T (backwards stroke of the carriage 15).

In case of a linear cylinder-piston actuator 37, for instance of the hydraulic or pneumatic type, it is configured to control only two different positions of the trajectory of the slide 13, and therefore of the rotating cutting blade 9.

The movement of the cylinder-piston actuator 37 is phased with the reciprocating translation movement of the carriage 15, but it is not necessary that they are perfectly synchronized. In fact, the positions for the start and the end of the cut are determined only by the relative position between the circular trajectory of the slide 13 (and therefore of the cutting edge of the rotating cutting blade 9) with respect to the axis of the mandrel 5. The trajectory is well defined and constant, thus assuring a mechanical accurateness of the cut length.

The movement of the cylinder-piston actuator 37 shall be coordinated with the reciprocating translation movement of the carriage 15, i.e. it shall be such to bring the hinge 33B to the position near the axis of the mandrel 5 sufficiently in advance with respect to the circular movement in the forward direction of the slide 13. This movement of the actuator 37 shall also be timed according to the reversal of motion of the carriage 15, so that the rotating cutting blade 9 is brought to the backward position (the hinge 33B shall be moved away from the axis of the mandrel 5) in such a sufficient time that the rotating cutting blade 9 does not interfere with the tube T in the return movement (in opposite direction with respect to fT).

As the position of the center of the circular trajectory, defined by the position of the hinge 33B, is determined by the actuator 37, this latter can be used to determine the start and end position for the cut of the tube T by means of the rotating cutting blade 9. The nearer the hinge 33B to the axis of the mandrel 5, the more advanced the point where the interaction starts between the rotating cutting blade 9 and the tube T, the more retarded the point where this interaction ends; this means that, the closer the hinge 33B to the axis of the mandrel 5, the longer the time the rotating cutting blade 9 remains in the tube T to be cut. The adjustment of the position of the cylinder-piston actuator 37 can be used to adjust the start and end points for the cut of the tube T.

In some embodiments, systems can be provided facilitating the adjustment of the position of the actuator 37 and therefore the position of the active trajectory of the rotating cutting blade 9. For instance, the cylinder-piston actuator 37 can be mounted onto a plate that can be adjusted by means of a screw system.

It is also possible to use a more complex actuator 37, rather than a simple cylinder-piston, for instance a linear electric motor or a motor with pinion-rack system, to translate the position of the hinge 33B. In this case, for instance by electronically controlling the actuator 37, it is possible not only to move the hinge 33B from the closer position to the more distant position with respect to the axis of the mandrel 5. It is also possible to electronically adjust the position of the hinge 33B near the axis of the mandrel 5 during the active forward stroke of the rotating cutting blade 9 so as to adjust the start and end position of the cut of the tube T. In other words, the start and end point where the rotating cutting blade 9 cuts the tube T can be electronically adjusted by acting on the actuator 37.

In some embodiments, it is also possible to use an electronically controlled actuator 37, which imparts the hinge 33B a gradual movement away from the axis of the mandrel 5 during the cutting step, i.e. during the forward movement of the carriage 15 according to fT. In this way, it is possible to impart a rectilinear trajectory, given from the combination of the movements according to fx and fy, imparted to the rotating cutting blade 9 and the slide 13. In this case, however, a very accurate synchronization is necessary between the movements of the actuator 37 and of the motor 23.

However, the use of a simple actuator 37, for instance a cylinder-piston actuator 37, ensuring only two positions, allows to obtain a precise cut by means of an economical system that is also easy to be maintained, to be programmed and controlled.

The movements described above are repeated cyclically at suitable intervals to cut the tube T into single sections or tubular cores (Al, FIG. 1A), whose length depends on the future use of the tubular cores Al.

1. A machine for producing tubes, comprising:
a mandrel, around which a tube is formed by winding at least one strip of web material, the mandrel having a longitudinal axis;
a winding unit to wind said at least one strip of web material around the mandrel;
a cutting unit comprising at least one rotating cutting blade provided with reciprocating motion to cyclically cut the tube being formed around the mandrel;
wherein the rotating cutting blade is constrained to move with a reciprocating motion along a circular trajectory; and wherein a center of the circular trajectory is controlled to be cyclically moved: into a position closer to the mandrel longitudinal axis during a forward stroke of the rotating cutting blade in a same direction as a feed direction of the tube being formed, where the at least one rotating cutting blade cuts the tube; and into a position farther away from the mandrel longitudinal axis during a back stroke of the rotating cutting blade in a direction opposite to the feed direction of the tube being formed.

2. Machine according to claim 1, wherein the rotating cutting blade is provided with an axis of rotation substantially parallel to the mandrel longitudinal axis.

3. Machine according to claim 1, wherein the rotating cutting blade is a toothed disc-shaped blade.

4. Machine according to claim 1, wherein: the rotating cutting blade is mounted onto a slide carried by a carriage provided with reciprocating motion in a direction substantially parallel to the mandrel longitudinal axis; the slide is movable with respect to the carriage in a direction substantially transverse to the mandrel longitudinal axis; and the slide is constrained to a control actuator which causes a controlled movement of said slide, to move the slide trajectory towards and away from the mandrel.

5. Machine according to claim 4, wherein a motor is mounted on the slide to actuate the rotating cutting blade, the motor moving integrally with the rotating cutting blade.

6. Machine according to claim 4, wherein the control actuator comprises a linear actuator.

7. Machine according to claim 6, wherein the slide is constrained to the linear actuator by means of a connecting rod articulated to the slide and the control actuator.

8. Machine according to claim 7, wherein the connecting rod is articulated to the control actuator and to the slide, and wherein the control actuator moves the point where the connecting rod is articulated to the actuator to move said point towards and away from the mandrel axis, so as to modify the trajectory of the slide and of the rotating cutting blade, moving said trajectory towards the mandrel during the forward stroke and away from the mandrel during the back stroke.

9. Machine according to claim 8, wherein: the cutting unit comprises one first guide which is substantially parallel to the mandrel longitudinal axis and onto which the carriage is arranged and moves; the carriage carries a guide substantially orthogonal to the mandrel longitudinal axis, onto which the slide is arranged and moves; and the control actuator is fixed to the slide by means of said connecting rod.

10. Machine according to claim 9, wherein integral with the first guide there is a bracket for supporting the control actuator, said control actuator being arranged on a side of the first guide and distanced therefrom.

11. Machine according to claim 6, wherein the linear actuator comprises a cylinder-piston actuator.

12. Machine according to claim 4, wherein the carriage is actuated by means of a rotating motor, and wherein a system is provided for converting the rotary motion of the motor into translational motion of the carriage.

13. Machine according to claim 12, wherein the converting system comprises a flexible member driven around pulleys, at least one of which is actuated by means of the rotating motor, and wherein the carriage is fixed to a branch of the flexible member.

14. A method for forming tubular cores from a continuous tube, comprising:
forming a tube around a mandrel in continuous fashion, said tube moving forward along the mandrel;
arranging a cutting unit along the mandrel, comprising a rotating cutting blade;
moving the rotating cutting blade along a circular trajectory cyclically performing: a forward stroke, during which the rotating cutting blade interacts with the tube being formed around the mandrel, moving forward in a same direction thereof to cut the tube; and a back stroke, during which the rotating cutting blade does not interact with the tube being formed;
wherein the center of the circular trajectory is arranged closer to the mandrel during the forward stroke and farther away from the mandrel during the back stroke.

15. Method according to claim 14, comprising:
arranging a first guide substantially parallel to the mandrel;
arranging a carriage moving with reciprocating rectilinear motion along the first guide;
arranging a second guide onto the carriage, the second guide being substantially orthogonal to the mandrel, the rotating cutting blade being arranged on the slide;
constraining the slide at a center of the circular trajectory;
translating the carriage along the first guide with reciprocating motion;
moving the center of the circular trajectory according to the movement direction of the carriage along the first guide.

16. A method for forming tubular cores from a continuous tube using the machine of claim 1, comprising:
winding the at least one strip of web material around the mandrel to form the tube around the mandrel in a continuous fashion;
moving the rotating cutting blade in the same direction as the feed direction of the tube being formed along the mandrel to cut the tube, the blade cooperating with the mandrel to cut the tube; and
moving the rotating cutting blade in a direction opposite to the feed direction of the tube being formed along the mandrel by moving said actuator and thereby moving the rotating cutting blade away from the mandrel.

17. A machine for producing tubes, comprising:
a mandrel, around which a tube is formed by winding at least one strip of web material, the mandrel having a longitudinal axis;
a winding unit to wind said at least one strip of web material around the mandrel;
a cutting unit comprising at least one rotating cutting blade mounted on a carriage provided with reciprocating motion in a direction substantially parallel to the mandrel longitudinal axis;
wherein: the rotating cutting blade is mounted on a slide carried by the carriage and moving with respect to the carriage in a direction substantially transverse to the mandrel longitudinal axis; the slide is fixed to a control actuator causing a controlled movement of the slide to move the slide towards and away from the mandrel, so as to put the rotating cutting blade in an active cutting position, during a forward stroke in a same direction as a feed direction of the tube being formed, and in an inactive position, during a back stroke.

18. A method using the machine of claim 17, comprising:
winding the at least one strip of web material around the mandrel to form the tube around the mandrel in a continuous fashion;
moving the rotating cutting blade in the same direction as the feed direction of the tube being formed along the mandrel to cut the tube, the blade cooperating with the mandrel to cut the tube; and
moving the rotating cutting blade in a direction opposite to the feed direction of the tube being formed along the mandrel by moving said control actuator and thereby moving the rotating cutting blade away from the mandrel.
